(19) United States
(12) Patent Application Publication
(10) Pub. No.: US 2024/0246352 A1
(43) Pub. Date: Jul. 25, 2024

(54) Stylus pen refill size improvement

(71) Applicant: Jamal Zuhour, Santa Ana, CA (US)

(72) Inventor: Jamal Zuhour, Santa Ana, CA (US)

(21) Appl. No.: 18/396,622

(22) Filed: Dec. 26, 2023

Related U.S. Application Data
(60) Provisional application No. 63/434,970, filed on Dec. 23, 2022.

(51) Int. Cl. B43K 11/00; B43K 8/24; B43K 24/06

(52) U.S. Cl. CPC B43K 11/00; B43K 8/24; B43K 24/06

(57) ABSTRACT

Stylus pens with continuous long surface solid body between the stylus part and pen extrusion action pen body offer high stylus sensitivity. Such pens with top stylus function offer better visibility while writing. To achieve this, the surface discontinuity used in the action function is located far from stylus (discontinuity results in poor electrical conduction). One of the solutions is to have a twist action mechanism (without mating threads) requires a press fit design. Due to use of press fit manufacturing/function/useful life, a typical short mechanism was used thus limiting the cartridge (refill) size. A typical mechanism is used into this class of pens (as in FIGS. 2 & 5), which intern limited cartridge size (e.g FIG. 2 holds only 90 cubic mm). This patent will change the mechanism design, solve the issues and take advantage of full body size (case of FIG. 2 to hold 500% ink).

### BRIEF DESCRIPTION OF THE DRAWINGS

FIG. 1 The main subject pen showing on the left the current used ink cartridge and on the right the possible ink cartridges that can be used after applying the changes (per this application).

FIG. 2 The common twist mechanism used by manufacturers showing the parts laying side by side with all components.

FIG. 3 The new design of the twist mechanism by taking advantage of most of the space inside the pen. All components are placed side by side to easily understand the assembly, and follow up the instructions for function and manufacturing points.

FIG. 4 An internal view of the new pen assembled showing the retracted (position A) and extended cartridge positions (position B) with the twist mechanism in action.

FIG. 5 Models with similar stylus top position and bottom twist action manufactured using the typical common twist mechanism, also can be changed to include high cartridge capacity by employing the procedures made per this new twist mechanism design changes.

### BACKGROUND

The subject stylus is the type with location of stylus on top, with twist action built in the bottom of the pen. This configuration offered continuous surfaces without interruption of the electrical charges from the hand to the pen main body to the stylus connection surface, and thus the capacitive type stylus function is best inherently in the design. This continuous and large area leads to reduced resistance and thus in a superior stylus functionality over other designs that are limited by very small contact points or thin line that are not constant and subject to the point contact resistance. Other models flow of electric charges resistance is irregular due to the moving parts nature and irregular resistance due to contact point resistance.

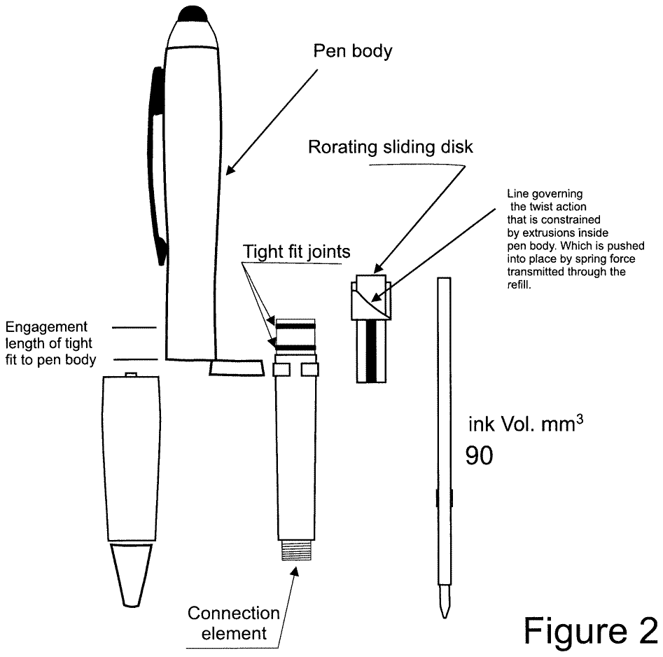

In prior designs the some manufacturers had inserted conductive object with large surface area inside the pen near the stylus, aiming at reducing the electrical resistance between the touching fingers and the intended capacitive contact surface. Such item occupied some volume from the body near the stylus and limited the left volume that can be used for the pen/twist mechanism combination. The used twist action mechanism has been of standard configuration and components' size used in all pens with such twist action (see FIG. 2). This offered only the ability to use small refill. The components size is easy to manufacture and all parts can fit easily and work seamlessly with little attention to design spec requirements. To manufacture larger twist action, the mechanism is based on tight fit between the twist action components and the upper body of the pen, such tight fit is not easy to maintain with large plastic parts. The pen comprises of a bottom part with the opening for the cartridge to extrude out of the mechanism.

### Background (Continued)

The other opening of this bottom part is fitted with the major part of the twist mechanism.

This whole bottom assembly is held into place with the upper body by a tight fit connector element that allows free rotation of the bottom part of the pen with respect to the body of the pen. The twist action mechanism, is also fitted to the bottom part of the pen. The twist mechanism comprises of a barrel and a piece fitted into it that is free to move just in a longitudinal way along pen axis. from the bottom of the pen has to be transmitted through a tightly fitted parts connecting the twisting mechanism outside the pen all the way to the moving parts that affect the location of the refill to be retracted or extended depending on the angle of rotation of a rotating disk governed by a track molded in the internal part of the upper pen body. Thus such action required circular of the mechanism in a tight fit with the upper body of the pen and hold the bottom part held with bottom part. And the rotating disk to be smoothly pushed and rotated to provide the push action of the refill. Such function and purpose are both governed by the tight fit between the parts, the manufacturing, and smoothness the function all play a role against each other. That is to say, a tighter fit will offer good pen construction strength and the parts are not easily separated during use and reduce the smoothness of the twist action. Such function can be achieved with smaller parts and result in smaller variations due to inherent tolerance in the plastic molding processes. Manufacturing larger twist action mechanism requires greater attention due to the fact that the tight tolerances are greatly affected in larger parts due to nature of plastic parts behavior in molding processes which greatly impacts the tolerances and thus the functionality of the twist mechanism (see the small size of engagement of tight fit in FIG. 2 for old typical mechanism.)

### SPECIFICATIONS

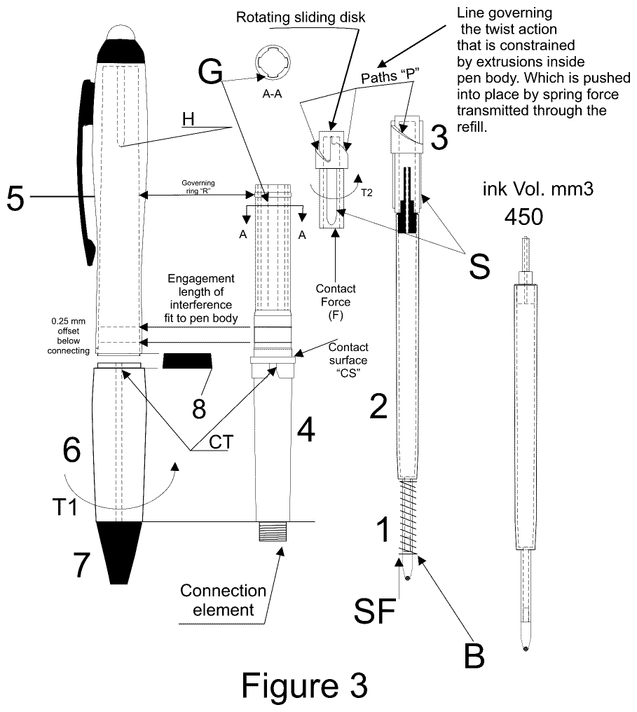

### Elements of the Mechanical Mechanism (See FIG. 3)

1—Spring (Contsrained by the distance between the bottom of the large ink reservoir and the pen tip (no. 7).
2—The total ink cartridge including nib, ink tube (inside the spring), large reservoir and cap.
3—Rotating sliding disk: —This is the governor linking the rotation action of the pen to the cartridge extrusion/retraction in/out of the pen cavity.
4—Connection element: Is the element that connects and constrains all mechanical elements.
5—The main body of the pen.
6—Grip/Twist torque application element, by applying the torque T1, this torque is transmitted to the connecting element through points CT. on both sides.
7—Pen tip: —with the opening for the cartridge movement in and out of the cavity. Acts as the bottom limit of the spring length, which will inturn provide the necessary force to keep the total length of 3 and 2 constant and always in full contact and acting as a unit to bottom limit plus spring length to Point “B”.
8—Connecting ring: It's faction is just for looks and plays a little part into aligning 6 (which has loose tolerances with 4) to pen body element 5.
P=Paths, the constraining path of the cartridge/disk assembly movement.
H=Limiting location along the body of the pen.
G=Groove in the connection element contraining the movement of the rotating disk along the axis of the connection element (4).
S=Sledge which is part of the rotating disk that will constrict the movement of the

### Specifications (Continued)

### Elements of the Mechanical Mechanism (Continued)

rotating disk (3) along the connection element (4) in the groove G. Also transmits the required torque required to rotate the disk/cartridge assembly.

Look at FIG. 3 for all the elements/key assembly points.

### Basis of Design

The Connection element provides the building infrastructure of the pen holding the system together and provides most parts of the mechanical foundation/base of the pen.

The bottom cap is screwed tight in the bottom, which limits the bottom location of the spring with respect the pen.

The applied torque to twist the pen is done through element 6 which has two inside rails that are
inserted in point CT. Thus torque is transmitted through 4 to the groove G. This torque is transmitted through the coupling of sledge S.

This coupling torque is transmitted to path G/point of contact to H on the pen Body which will result in tangent force to let the mechanism overcome the friction forces due to rotation of the entire mechanism as well to compress the spring to alter the length of the 3&2 with Point B. Thus extrusion or retraction of the cartridge.

There is a small clearance between the groove ring “R” “about 0.25 mm. (which is part of the connecting element) and the pen body, which allows free rotation and least smooth contact area, to limit both the wobble of the element and to keep the rotating disk on body path H. The interference fits between the connection element (4) and pen body (5)

### Specifications (Continued)

### Basis of Design: (Continued)

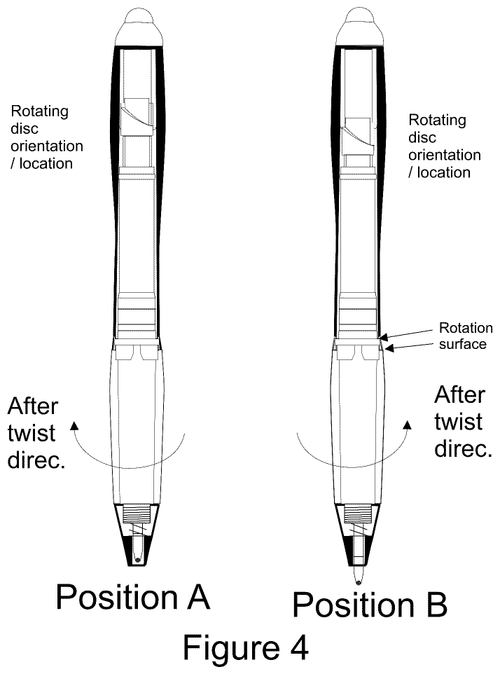

is small and is overcome by manually forcing it inside (about 0.015 mm). Two of them which are 0.25 mm limited by the contact of 5 to CS and the interference fits) after engagement and free rotation. Hence allowing enough tolerances for manufacturing/assembly and twist function. The touch stylus element is located on the top of the pen, and touching is done on the outer surface of the rubber. The nature of electricity that it travels on the surface of the connector (plastic body is sprayed with metallic coating). Therefore the sensitivity of the pen is not increased significantly by placing inside connecting sheet and connecting it to the surface of the pen body. In our case the connection surface is huge. Therefore the stylus sensitivity was not negatively affected by this change. The old design interference fit and the total engagement inside the body was small (limited by the two rings), resulting in big angular misalignment between the connection element and the body. In the new design such length is increased two three points along (two interference fit rings and the Groove Ring “R”. Which allows for better smoother function, more solid feel and less wobble of the rotating disk. Therefore the overall mechanical function is improved. Look at FIG. 4 showing the cut body showing the extended/retracted cartridge positions.

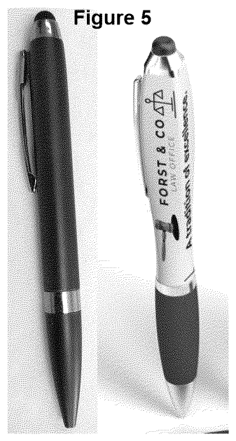

Look at pictures in FIG. 5 for possible similar models of application.

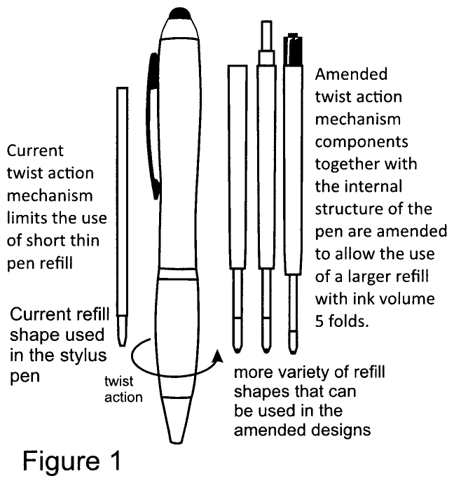

1. Stylus pens (Limited to top position) with bottom twist action have high sensitivity of stylus function (due to lower current resistance between the pen body and stylus tip: —inherent in the design). Currently twist action mechanism with standard market design has been used in all similar pens with twist action in the bottom. This typical design is manufactured to meet the tight tolerances required by the tight fit of the assembled components with the pen body. The entire pen industry is using one typical twist action design/with almost standard components size. This has been a practice for over 10 years (shown in FIG. 2, is the typical one). In addition to the twist action typical size/components design the added components inside twist action to allow the use of larger capacity ink cartridge (5 folds), which will result the pen aiming at enhancing the stylus sensitivity also added to the limiting factor of refill in more consumer useful life of the pen. The amended structure with the large capacity size and ended all up in a very thin and short refill. Hence, the useful writing length of the cartridge will be evaluated based on the impact on the stylus sensitivity item which greatly pen is greatly reduced. This patent will modify the internal structure of the pens and the affects the available volume for refill mechanism. The amended structure will be employed using techniques to maintain smooth twist action and or maintain sensitivity of the stylus tip function (the amended pen structure will also impact such components). And thus, the modified structure/components of the twist action together with the new internal pen designs are patentable due to the improvement of useful writing length, in addition to maintaining stylus sensitivity and smooth twist action by applying techniques not used in the typical mechanism. Large capacity cartridges are shown in FIG. 1 are not limited to these shapes/combo with cap.
